(19) United States
(12) Patent Application Publication
(10) Pub. No.: US 2016/0283657 A1
(43) Pub. Date: Sep. 29, 2016

(54) METHODS AND APPARATUS FOR ANALYZING, MAPPING AND STRUCTURING HEALTHCARE DATA

(71) Applicant: General Electric Company, Schenectady, NY (US)

(72) Inventors: Rahul Bhotika, Schenectady, NY (US); Rui Li, Niskayuna, NY (US); Aravind Chandramouli, Bangalore (IN); Sheng Yi, Niskayuna, NY (US); Ravi Kiran Reddy Palla, Niskayuna, NY (US)

(21) Appl. No.: 14/667,114

(22) Filed: Mar. 24, 2015

(51) Int. Cl. G06F 19/00

(52) U.S. Cl. CPC G06F 19/321; G06F 19/3487; G06F 19/345

(57) ABSTRACT

Methods and apparatus for analyzing, mapping and structuring healthcare data are disclosed. An example method includes parsing a clinical report to identify a parameter within the clinical report and associated with an image. The clinical report is associated with the image. The example method includes, when the parameter is identified in the parsing, analyzing the image to determine a value of the parameter, mapping the value, the image, and the clinical report to a model and generating an output to display one or more of the value, the image, or the clinical report.

### FIELD OF THE DISCLOSURE

This disclosure relates generally to healthcare systems, and, more particularly, to methods and apparatus for analyzing, mapping and structuring healthcare data.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information and/or scheduling information.

### BRIEF DESCRIPTION OF THE DRAWINGS

FIG. 1 is an example block diagram of an example healthcare environment that can be used to analyze, map and structure healthcare data.

FIG. 2 is an example flow diagram that can be used to implement the example healthcare environment of FIG. 1.

FIGS. 3-6 are example user interfaces that can be used to implement to example healthcare environment of FIG. 1.

FIG. 7 is a flowchart representative of machine readable instructions that may be executed to implement the example healthcare environment of FIG. 1.

FIG. 8 is a processor platform to execute the instructions of FIG. 7 to implement the healthcare environment of FIG. 1.

The figures are not to scale. Wherever possible, the same reference numbers will be used throughout the drawing(s) and accompanying written description to refer to the same or like parts.

### DETAILED DESCRIPTION

The examples disclosed herein enable healthcare clinicians to make more informed decisions at the time of diagnosis. Some examples disclosed herein provide a structured analysis and/or report (e.g., a patient centric picture) to clinicians including imaging data (e.g., images from one or more modalities), non-imaging data and a correlation between the imaging data and non-imaging data including data from external sources and/or prior studies (e.g., reports, annotation, waveforms, dictations, etc.). In some examples, the imaging and/or non-imaging data and any corresponding analysis results are indexed and/or mapped based on standard medical terms (e.g., common medical language) to enable, for example and among other things, collaboration between different specialists, thereby improving access to other clinicians in the value chain and/or improving patient care through personalized precision medicine.

In some examples, the structured analysis and/or report is tailored to the particular patient and/or organized to enable increased value to a healthcare clinician. For example, certain aspects disclosed herein may analyze and/or correlate non-imaging and imaging data and automatically update the imaging and/or non-imaging data based on the analysis and/or generate a structured report including labels and/or measurements obtained from the analysis. To assist in clinical decision support and enable verifications and/or error checking to occur (e.g., left/right consistency, identification of unusual sudden changes, etc.), in some examples, the structured report generated includes links to prior studies. In some examples, the structured report generated includes multimedia demonstrations such as trend/longitudinal analysis within and/or embedded within the structured report.

Using the examples disclosed herein, non-imaging data and imaging data may be integrated and/or correlated to enable further analysis, mapping and/or structured reports to be generated. In some examples, integrating and/or correlating the imaging and/or non-imaging data includes integrating the radiology information system (RIS) and the picture archiving and communications system (PACS), for example. In some examples, integrating and/or correlating the imaging and/or non-imaging data includes text parsing, text retrieval, imaging parsing and/or image retrieval. In some examples, based on the text retrieval results and/or the image retrieval results, imaging data can be automatically analyzed by, for example, determining parameter values, identifying a portion of the image, outlining a portion of the image, establishing a link between the image and the text and/or other data, etc. In some examples, based on the text retrieval results, the image retrieval results and/or the imaging data analysis, structured reports may be automatically generated as, for example, a decision support tool for healthcare clinicians and/or selected workflows.

Using the examples disclosed herein, a system providing a relatively complete offering for reporting, analysis and/or recommendations for further examination(s) may be provided to healthcare clinicians in which tools and/or data are embedded into the workflow. In some examples, the data embedded into the workflow includes imaging data, non-imaging data, results obtained based on imaging data analysis and/or non-imaging data analysis and/or other relevant findings related to the patient, another patient, study and/or data. In some examples, the other relevant finding(s) include prior data associated with a prior exam undergone by the patient and/or an article(s), an external reference(s) associated with the imaging data, the non-imaging data, the imaging data analysis and/or non-imaging data analysis, etc.

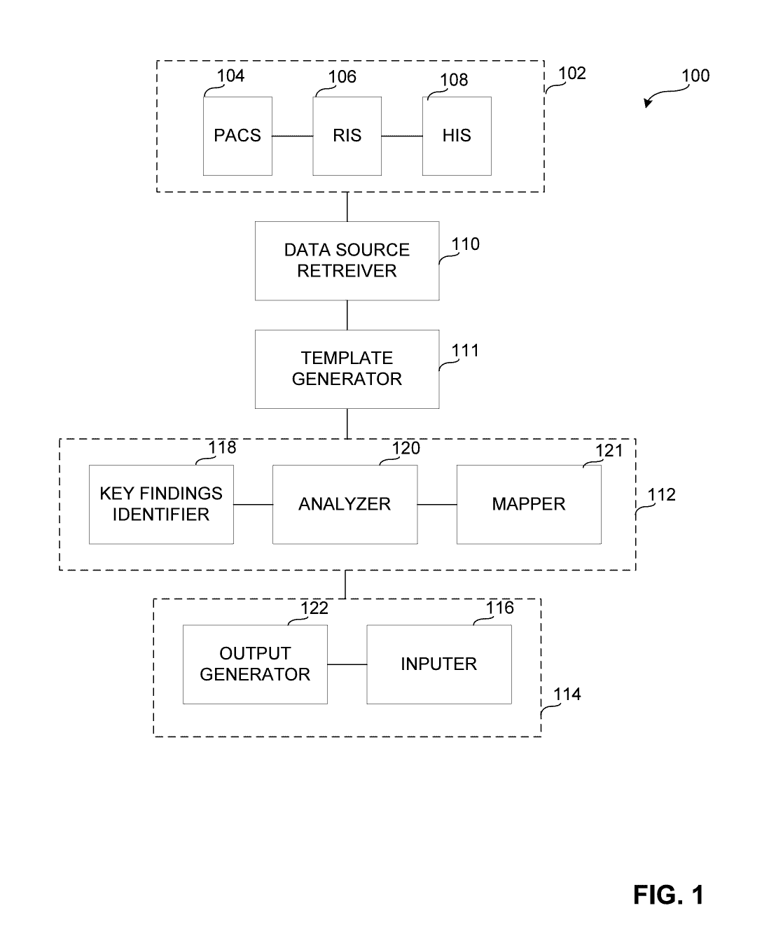

FIG. 1 is a block diagram of an example healthcare environment 100 in which the example methods and apparatus for analyzing, mapping and structuring healthcare data may be implemented. The example healthcare environment 100 includes data sources 102 having a plurality of entities operating within and/or in association with a hospital. The data sources 102 include a picturing archiving and communication system (PACS) 104, a radiology information system (RIS) 106, a Healthcare Information System (HIS) 108. However, the data sources 102 may include more, less and/or different entities than depicted such as a laboratory information system, a cardiology department, an oncology department, etc.

The PACS 104 stores medical images (e.g., x-rays, scans, three-dimensional renderings, etc.) such as, for example, digital images in a database or registry. Images are stored in the PACS 104 by healthcare practitioners (e.g., imaging technicians, physicians, radiologists) after a medical imaging of a patient. Additionally or alternatively, images may be automatically transmitted from medical imaging devices to the PACS 104 for storage.

The RIS 106 stores data related to radiology practices such as, for example, radiology reports, messages, warnings, alerts, patient scheduling information, patient demographic data, patient tracking information, and/or physician and patient status monitors. Additionally, the RIS 106 enables exam order entry (e.g., ordering an x-ray of a patient) and image and film tracking (e.g., tracking identities of one or more people that have checked out a film).

The HIS 108 may include a Financial Information System (FIS), a Pharmacy Information System (PIS), a Laboratory Information System (LIS), etc. In some examples, the HIS recommends the correct modality and/or parameter settings to use. In some examples, the examples disclosed herein can be implemented in an imaging modality such as, for example, an x-ray machine, an ultrasound scanner, an MRI, etc. The HIS 108 may be used by any healthcare facility, such as a hospital, clinic, doctor's office, or other medical office.

In some examples, the data sources 102 include imaging and/or non-imaging data that are used by a data source retriever 110, a template generator 111, a data integration manager 112 and/or a practitioner interface 114 to provide a practitioner with structured data. In some examples, the structured data includes imaging and non-imaging data that is correlated and/or structured for clinical decision support. To initiate decision support analytics and in response to clinician input, in some examples, the data source retriever 110 retrieves, indexes and/or queries imaging and/or non-imaging data related to the patient and/or other sources. The clinician input may include a patient symptom(s) and/or an annotation and/or dictation from the practitioner (e.g., a mammogram). The data obtained by the data source retriever 110 may include patient RIS data, patient HIS data, medical record data, medical report data, data from external sources, etc. In some examples, some of the data obtained by the data source retriever 110 is obtained by reviewing and/or parsing past studies, publications and/or guidelines. In some examples, the data obtained by the data source retriever 110 is used by the healthcare environment 100 for diagnostic and/or prognostic purposes.

In response to the data obtained by the data source retriever 110 and/or other input received (e.g., input from a practitioner), the template generator 111 automatically generates and/or obtains a report template(s) to be used and/or populated. In some examples, the template generator 111 may receive input and/or approval from a practitioner on the template. For example, the template generator 111 may identify one or more templates for review, selection and/or approval by a practitioner using the practitioner interface 114. In some examples, the practitioner may approve and/or select a template being displayed using an input interface 116 (e.g., a pull down menu, a selection box, etc.) of the practitioner interface 114. However, in other examples, the template generator 111 may automatically select and/or generate a template without input from the practitioner.

In response to the template generator 111 selecting and/or generating a template and/or other input received, a key findings identifier 118 of the data integration module 112 reviews the data obtained from the data source retriever 110 and/or the template to identify one or more key findings and/or parameters. In some examples, the key findings identifier 118 may review and/or parse non-imaging data to identify and/or extract one or parameters within a clinical report and/or contained within the template. The parameters identified within the clinical report (e.g., non-imaging data) may be associated with a portion of an image. For example, when reviewing breast cancer screening data, the key findings identifier 118 parses the image data into a fatty tissue area(s) and a fibuglandular tissue area(s) to enable a density value to be computed. In some such examples, the determined value is automatically populated within a report and/or template as discussed further herein.

In operation, in response to receiving a clinical report and/or non-imaging data relating to a mammogram, for example, the key findings identifier 118 may compare one or more words and/or phrases within the clinical report to a reference list of parameters to dynamically identify parameters such as, for example, “breast density,” “lesion shape,” “lesion size,” “calcification, “lump,” “mass,” etc. within the clinical report. Thus, in such examples, the parameters being identified by the key findings identifier 118 are dynamically and automatically defined. In other words, depending on the clinical report received and the specific words and/or phrases contained within the different clinical reports, the key findings identifier 118 dynamically identifies and/or defines different parameters. Additionally and/or alternatively, in some examples, the key findings identifier 118 identifies the parameter by reviewing contextual information of the current case and/or retrieved cases. Additionally and/or alternatively, in some examples, the key finding identifier 118 may identify one or more parameters (e.g., fields) included in the template.

In response to the parameters identified within, for example, a clinical report, the key findings identifier 118 searches for and/or identifies similar cases and/or external references related to the parameter. In some examples, the similar case(s) and/or the related reference(s) is displayed to the practitioner using the practitioner interface 114 and/or the similar case(s) and/or the related reference(s) is used by an analyzer 120 in connection with analyzing an image. In some examples, the analysis includes comparing a reference image to an image associated with the patient (e.g., a target image, an image obtained during a recent imaging session, an image, etc.) to identify one or more portions of the image. In some examples, to assist in clinical decision support, the key findings identifier 118 highlights or otherwise identifies related findings within the similar case(s) and/or the external reference(s).

In response to the parameters identified (e.g., dynamically defined by the key findings identifier 118), in some examples, the analyzer 120 of the data integration module 112 analyzes imaging data to capture quantitative values from the imaging data. The analysis may include image segmentation, image registration, measurement of an item(s) of interest identified within the image, diagnostic analysis, prognostic analysis, etc. For example, if the analyzer 120 identifies the parameter “lesion size,” the analyzer 120 automatically reviews and/or parses the image data to identify a location of a lesion. Additionally and/or alternatively, in some examples, the analyzer 120 determines a size measurement, a shape value, etc., of the lesion identified using, for example, automatic lesion segmentations processes.

In some examples, the analyzer 120 reviews past studies, publications and/or guidelines and/or data related to the current case and/or retrieved cases to more accurately identify different aspects of the image and/or determine different parameter values associated with the image. For example, based on the analyzer 120 identifying the patient as a young adult with a white-matter lesion from data relating to the current case and a hint of frontal lobe and compressed lateral ventricle from data relating to a retrieved case(s), the analyzer 120 identifies and/or outlines a tumor included in the image data. In some examples, the analyzer 120 may use an atlas-guided segmentation tool to outline the tumor. Additionally and/or alternatively, in some examples, the analyzer 120 analyzes past studies, publications and/or guidelines to identify a recommendation(s) and/or a diagnostic suggestion(s) associated with the parameter(s) and identified by the key findings identifier 118.

In this example, the data integration module 112 includes a mapper 121 that maps imaging and/or non-imaging data identified by the key findings identifier 118 and/or findings determined by the analytics of the analyzer 120 to a model. In some examples, the mapper 121 dynamically defines, generates and/or updates the model based on the parameter(s) identified by the key findings identifier 118 and/or the analysis performed by the analyzer 120. Additionally and/or alternatively, the mapper 121 maps data to the template selected and/or generated by the template generator 111.

In operation, for example, the mapper 121 links a lesion mentioned in the non-imaging data to a lesion depicted in the imaging data (e.g., the location of the lesion, the size of the lesion, the shape of the lesion, etc.). In some examples, the linking and/or analyzing is established and/or provided using the report template. For example, using the report template, the analyzer 120 determines which aspects of the image should be detected and/or processed (e.g., in a lung nodule case, the analyzer 120 detects nodules based on an analysis of the report template) to substantially ensure that the portions of the image being analyzed and/or processed are the portions that are relevant to the clinician and/or the tests being conducted. In some examples, the link between the imaging data and/or non-imaging data may be abstracted as a concept and/or a label such as an anatomical part(s), a lesion and/or a tumor description to more clearly describe the portions of the image within the non-imaging data and/or the imaging data. In some such examples, the mapper 121 maps labels associated with the parameter(s) and/or parameter value(s) to the model to be stored and/or associated with the image. Additionally and/or alternatively, in examples in which the patient symptom relates to a brain tumor, in some examples, the mapper 121 maps images such as magnetic resonance (MR) images and/or computed tomography (CT) images including a volume of the brain tumor, a measurement(s) of the brain tumor and/or a growth rate(s) to a model and/or an electronic medical record.

In response to the data integration module 112 identifying parameters and/or associated values and/or based on data mapped to the model, in some examples, an output generator 122 of the practitioner interface 114 automatically generates a structured report that may be used as a clinical support tool. Automatically generating the structured report increases efficiency of the practitioner by reducing and/or eliminating an amount of time that the practitioner dictates and/or inputs parameters and/or finding into the report generated and/or corrects transcription errors. In some examples, the out is generated based on the template. For example, fields of the template can be automatically determined and/or computed using image analysis. Some imaging analysis includes, without limitation, for example, nodule size, nodule shape, breast density, etc. In some examples, the report template is an XML file having predefined fields and different templates may be used depending on the situation, patient and/or the type of clinician being seen.

In some examples, the structured report includes the parameters and/or parameter fields and/or associated parameters values determined by the data integration module 112. In some examples, the data output by the output generator 122 can be modified by the input interface 116. For example, the input interface 116 enables a practitioner to add text, notations, and/or dictate data into the data displayed (e.g., the clinical medical record, etc.).

In some examples, the data sources 102, the data source receiver 110, the template generator 111, the data integration manager 112, the practitioner interface 114 and, more generally, one or more components of the healthcare environment 100 work together using case based retrieval and/or case based reasoning to assist in clinical decision support. In some examples, such case based retrieval and/or case based reasoning is used by the key findings identifier 118 to dynamically define parameters of interest using data relating to a current case and/or data relating to a previous case(s). Some parameters include, for example, prior imaging intensity information of the nodule, the location of the nodule and/or the shape of the nodule, etc. In some examples, such case based retrieval and/or case based reasoning is used by the analyzer 120 to dynamically define and/or label a region(s) of interest within an image and/or to determine a value(s) of a parameter(s). The data obtained and/or generated by the components of the healthcare environment 100 reduce the workload on a practitioner by increasing workflow efficiency and/or providing actionable information within the report generated. In some examples, the output is used to determine breast density, parenchymal texture. In some examples, based on the processing disclosed herein such as, for example, a determined Breast Imaging Reporting and Data System (BI-RADS) score determined using the examples disclosed herein, a recommendation on a next action(s) can be made. In some such examples, quantitative information and/or data obtained and/or generated using the examples disclosed herein is used when determining a next step determination.

While an example manner of implementing the hospital environment 100 of FIG. 1 is illustrated, one or more of the elements, processes and/or devices illustrated in FIG. 1 may be combined, divided, re-arranged, omitted, eliminated and/or implemented in any other way. Further, the example data sources 102, the example PACS 104, the example RIS 106, the example HIS 108, the example data source retriever 110, the example data integration manager 112, the example key findings identifier 118, the example analyzer 120, the example practitioner interface 114, the example mapper 121, the example input interface 116, the example output generator 122 and/or more, more generally, the example hospital environment 100 of FIG. 1 may be implemented by hardware, software, firmware and/or any combination of hardware, software and/or firmware. Thus, for example, any of the example data sources 102, the example PACS 104, the example RIS 106, the example HIS 108, the example data source retriever 110, the example data integration manager 112, the example key findings identifier 118, the example analyzer 120, the example practitioner interface 114, the example mapper 121, the example input interface 116, the example output generator 122 and/or more, more generally, the example hospital environment 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data sources 102, the example PACS 104, the example RIS 106, the example HIS 108, the example data source retriever 110, the example data integration manager 112, the example key findings identifier 118, the example analyzer 120, the example practitioner interface 114, the example mapper 121, the example input interface 116, the example output generator 122 and/or more, more generally, the example hospital environment 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example hospital environment 100 of FIG. 1 may include one or more elements, processes and/or devices in addition to, or instead of, those illustrated in FIG. 1, and/or may include more than one of any or all of the illustrated elements, processes and devices.

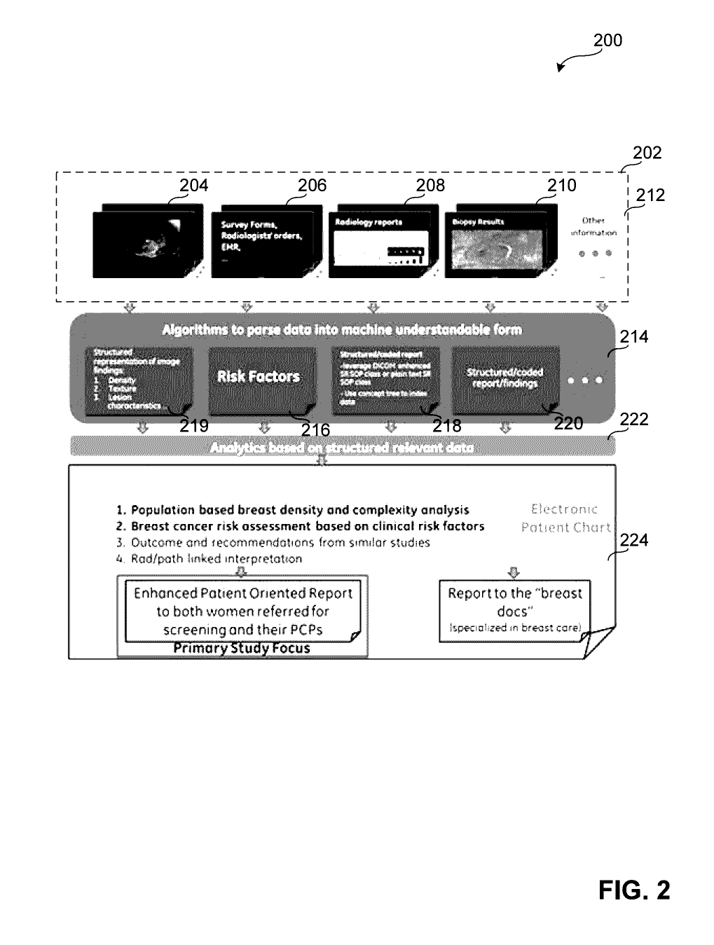

FIG. 2 is a data flow diagram 200 that can be used to implement the example hospital environment 100 of FIG. 1. In some examples, block 202 can be implemented by the data source retriever 102. As shown in FIG. 2, in this example, block 202 includes imaging data 204, survey forms, radiologist orders and/or an electronic medical record 206, radiology reports 208, biopsy results 210 and other information 212. However, in other examples, the block 202 may include different data (e.g., more types of data, less types of data, different types of data, etc.).

Block 214 can be implemented by the data integration manager 112 using data obtained from block 202 and/or the data source retriever 102. As shown in FIG. 2, in this example, block 214 includes algorithms to parse data into a machine understandable form. For example, using the instructions of block 214, the data integration manager 112 can extract knowledge from imaging data and/or non-imaging data (e.g., population based disease risk assessment). Additionally and/or alternatively, in some examples, using the instructions of block 214, the data integration manager 112 can identify (e.g., dynamically identify) one or more parameters of interest (e.g., key findings) from non-imaging data and/or prior case data (e.g., imaging data and/or non-imaging data) and then review and/or parse imaging data to identify and/or define the parameters of interest. In some examples, in analyzing the imaging data, the data integration manager 112 considers risk factors 216. The risk factors 216 may include the age of the patient, the gender of the patient, the history of patient, etc. In some examples, based on the analysis of the data (e.g., the imaging data and/or the non-imaging data), the data integration manager 112 maps findings to a structured and/or coded report 218 and/or provides a structured representation of the image 219. In some such examples, the data integration manager 112 maps textual and/or image features and/or data to a radiology concept such as, for example, anatomy, pathology, etc. In this example, the structured representation of the image 219 includes density data, texture data, lesion data and/or other characteristics of the image identified and/or analyzed by the data integration manager 112.

In some examples, the data integration manager 112 leverages digital imaging and communications in medical (DICOM) enhanced structured reporting (SR) service-object pair (SOP)class and/or plain text SR SOP class to store, query and/or retrieve the data (e.g., results of analysis, data analyzed, related findings, data, etc.). In some examples, the data integration manager 112 enables the generation of a structured and/or coded report and/or findings 220 by parsing clinical information into a structured form and/or using the parsed data to extract relevant information.

Block 222 can be implemented by the data integration manager 112. In some examples, the data integration manager 112 performs analytics on the structured data to provide a recommendation(s) to a practitioner. For example, in some examples, the data integration manager 112 combines a model and image analysis data from the analyzer 120 to provide a recommendation on a next action to be taken (e.g., another procedure, another exam, etc.). In some such examples, the data integration manager 112 and/or the practitioner interface 114 combines a GAIL model and image texture analysis from the analyzer 120 to determine a risk score to enable a practitioner to make a patient recommendation. In some examples, the patient recommendation includes recommending an additional imaging exam such as, for example, an ultrasound, a contrast enhanced mammogram, a magnetic resonance imaging (MRI), etc. In some such examples, to further improve the quality of a recommendation by the practitioner, the data integration manager 112 obtains a population plot including risk scores on which the patient's score is also included to enable a patient recommendation.

Block 224 can be implemented by the practitioner interface 114 using data obtained from block 214, the data source retriever 102 and/or the data integration manager 112. In some examples, at block 224, the practitioner interface 114 displays, based on data obtained from the data integration manager 112, relevant patient information such as, for example, population based breast density and complexity analysis, breast cancer risk assessment based on clinical risk factors, outcome and recommendations from similar studies, a radiologic linked interpretation(s), a pathology linked interpretation(s), etc. Additionally and/or alternatively, in some examples, at block 224, the practitioner interface 114 provides access to the electronic patient chart and/or other links to additional data such as, for example, breast documents, enhanced patient oriented report and/or primary study focus, etc., identified by the data integration manager 112.

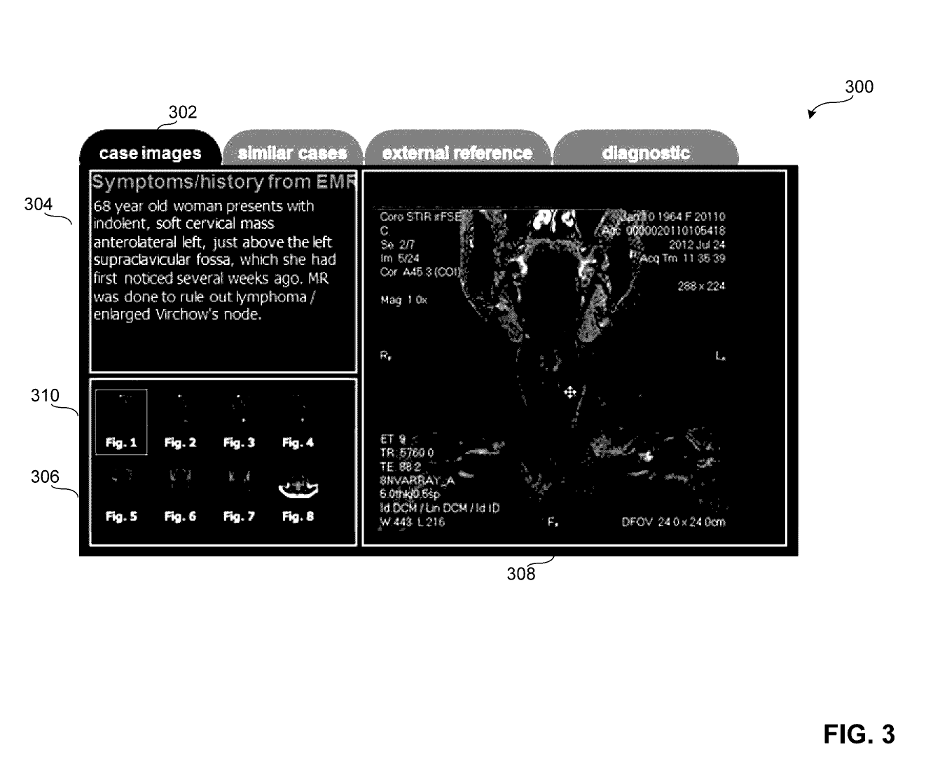

FIGS. 3-6 are example user interfaces 300, 400, 500 and 600 that can be used to implement the practitioner interface 114 and/or the one or more components of the healthcare environment 100. Referring to the user interface 300 of FIG. 3, a case images tab 302 is selected and a first portion 304, a second portion 304 and a third portion 306 of the user interface 300 is shown. In some examples, the inputs include current exam images(s), the purpose of the exam and/or the exam type. In some examples, the input includes medical records associated with the case. In some examples, based on the extracted information from current exam images (lesion size, shape, etc.) and key information from medical recordings, the examples disclosed herein can search the other resources (e.g., the internet, an internal database, an external database) to obtain additional case relevant information.

In the example of FIG. 3, the first portion 304 shows symptoms/history from an electronic medical report obtained using, for example, the data source retriever 110 at block 102 and displayed using, for example, the practitioner interface 114 at block 224. In the example of FIG. 3, the second portion 306 shows various selectable images obtained using, for example, the data source retriever 110 at block 102 and displayed using, for example, the practitioner interface 114 at block 224. In the example of FIG. 3, the third portion 308 shows an enlarged view of the one image 310 selected within the second portion 306 obtained using, for example, the data source retriever 110 at block 102 and displayed using, for example, the practitioner interface 114 at block 224.

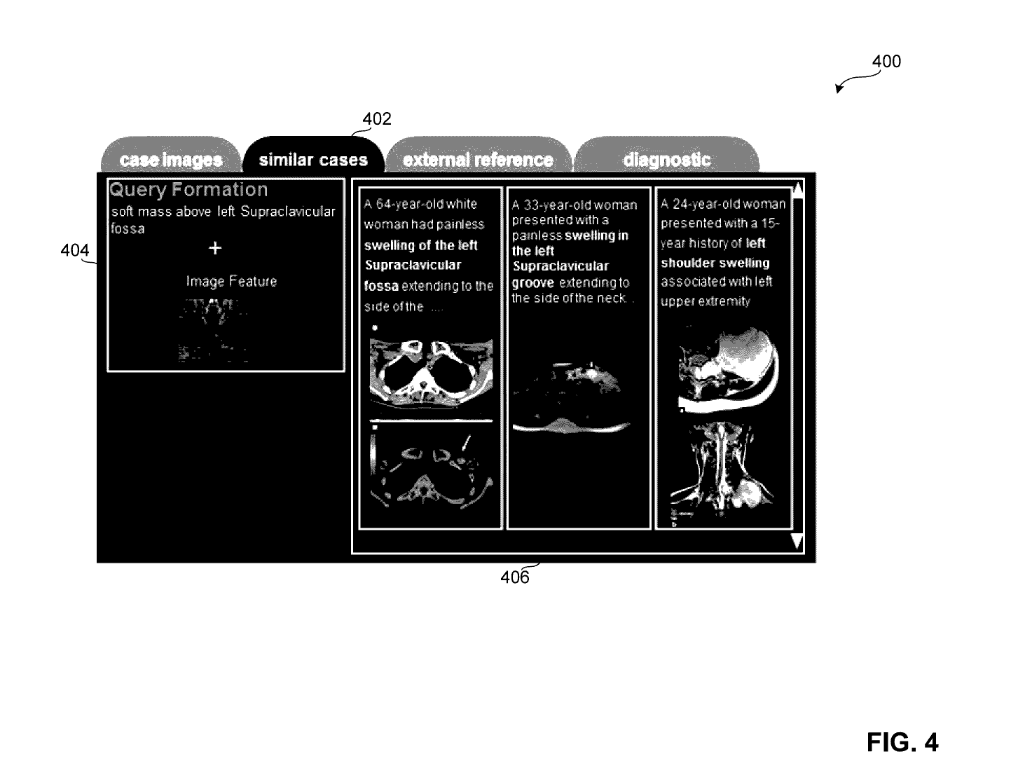

Referring to the user interface 400 of FIG. 4, a similar cases tab 402 is selected and a first portion 404 and a second portion 406 of the user interface 400 is shown. In this example, the first portion 404 of the user interface 400 includes data used to form a query including a description and an image feature obtained using, for example, the data integration manager 112 at block 214 and displayed using, for example, the practitioner interface 114 at block 224. To form a query, in some example, text analytics included within the data integration manager 112 at block 214 extract key words from non-imaging data, image analytics included within the data integration manager 112 at block 214 extract image features from imaging data and analytics included within, for example, the data integration manager 112 at block 214 map the textual and image features to radiology concepts such as anatomy, pathology, etc. In this example, the second portion 406 includes scrollable search results of similar cases based on the query obtained by the data integration manager 112 at block 214.

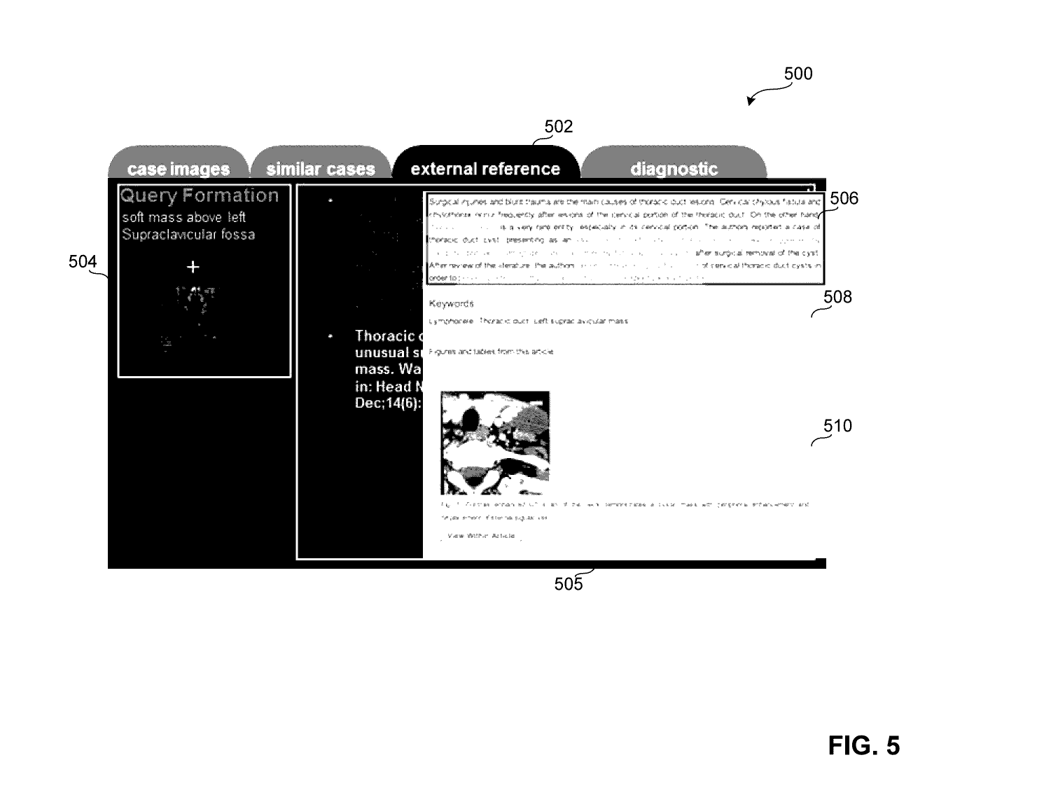

Referring to the user interface 500 of FIG. 5, an external reference tab 502 is selected and a first portion 504 and a second portion 505 of the user interface 500 is shown. In this example, the first portion 504 of the user interface 500 is substantially similar to the first portion 404 of FIG. 4 and includes data obtained using the data source retriever 110 at block 212 and/or the data integration manager 112 at block 214. In this example, the second portion 505 includes scrollable search results of similar external references based on the query conducted by, for example, the data integration manager 112 at block 214 and/or displayed using, for example, the practitioner interface 114 at block 224. In this example, the second portion 504 includes data provided by, for example, the data integration manager 112 at block 214 including a highlighted excerpt of a relevant portion of an external reference 506, a list of key words 508 identified within the external reference and a FIG. 510 identified as relevant based on the query.

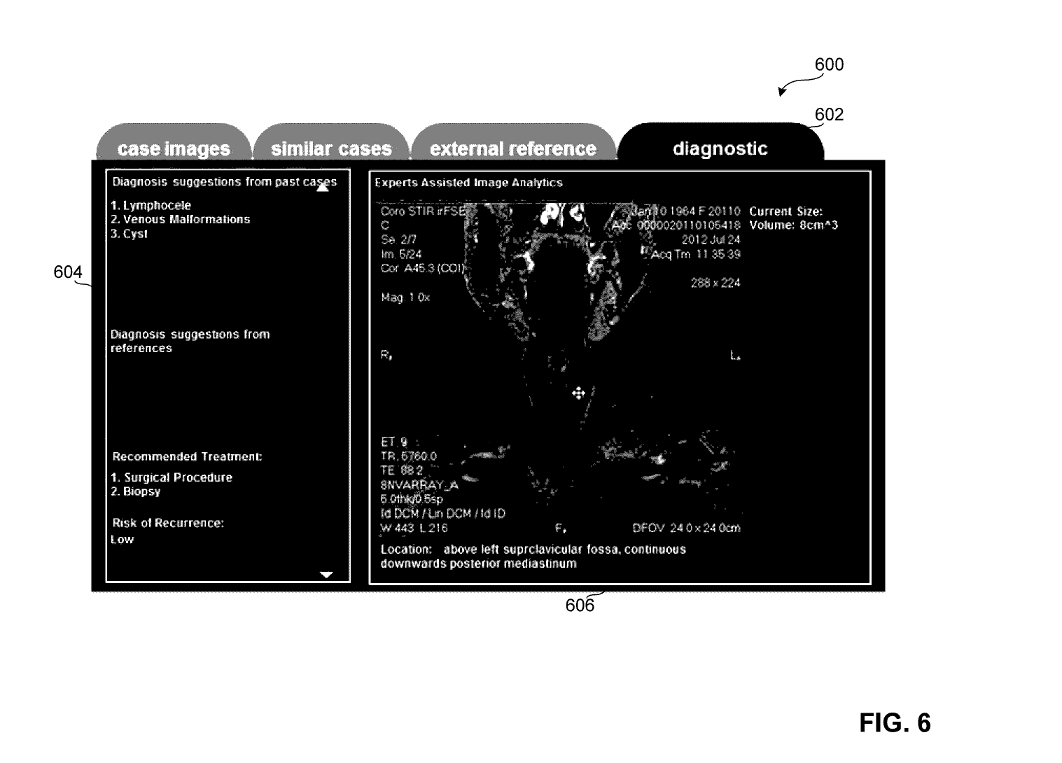

Referring to the user interface 600 of FIG. 6, a diagnostic tab 602 is selected and a first portion 604 and a second portion 606 of the user interface 600 is shown. In this example, the first portion 604 of the user interface 600 includes diagnostic suggestions determined by, for example, the data integration manager 112 at block 214 and displayed using, for example, the practitioner interface 114 at block 224. In this example, the diagnostic suggestions include diagnostic suggestions from past cases, diagnostic suggestions from references, a recommended treatment and a risk of reoccurrence. In this example, the second portion 606 includes a labeled image provided by, for example, the data integration manager 112 at block 214 and displayed using, for example, the practitioner interface 114 at block 224. In some examples, the image is labeled using imaging analytics using retrieval results. The imaging analytics included within the data integration manager 112 may include segmentation, auto-key anatomy labeling, automatic measurement of a nodule(s) and/or a description of a location of a nodule(s) with respect to a neighboring anatomy.

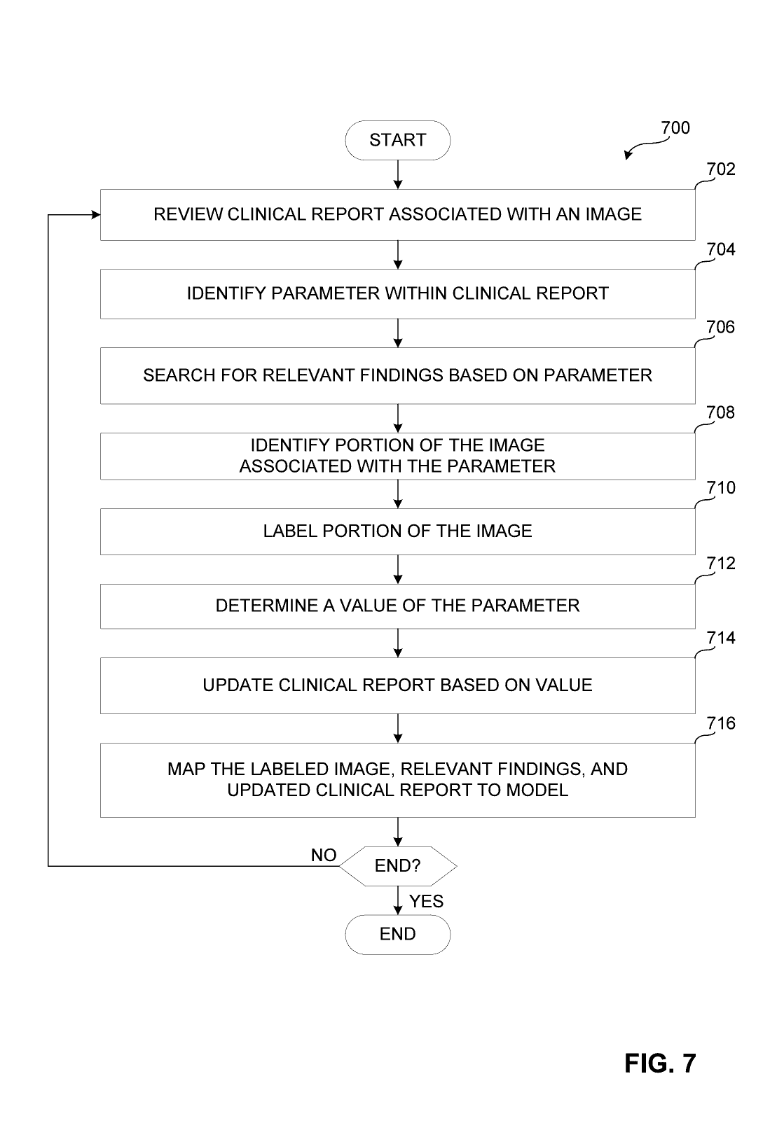

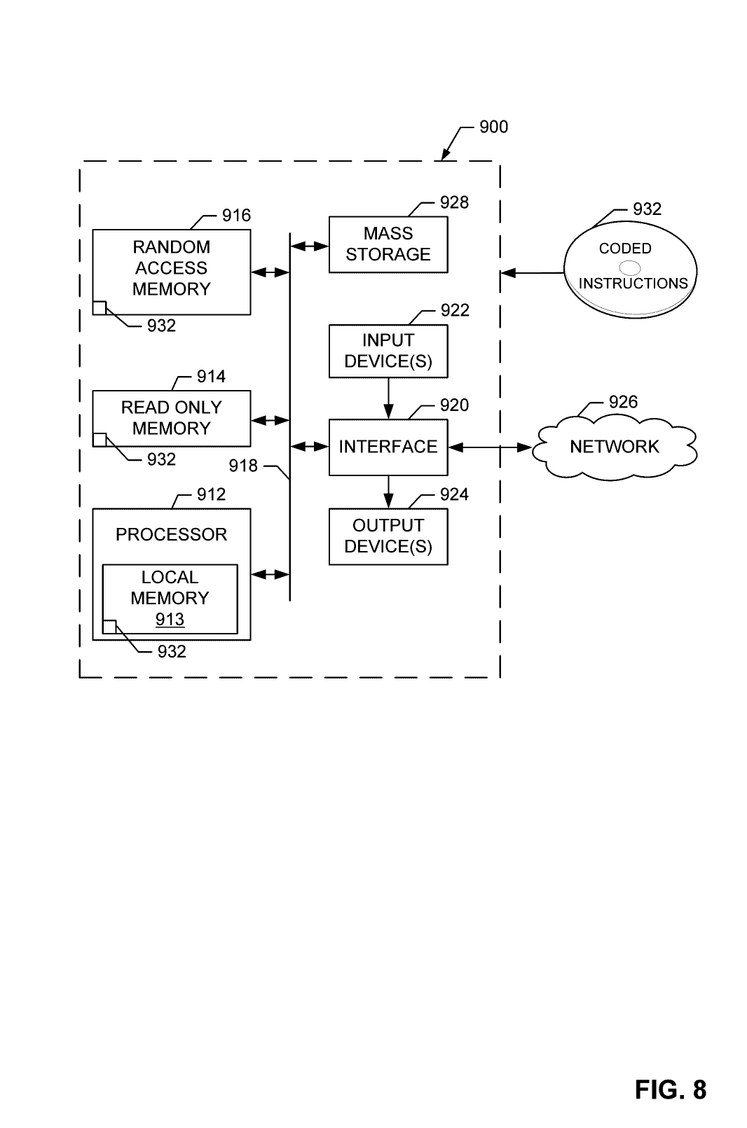

A flowchart representative of example machine readable instructions for implementing the hospital environment 100 of FIG. 1 is shown in FIG. 7. In this example, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 7, many other methods of implementing the example healthcare environment 100 may alternatively be used. For example, the order of execution of the blocks may be changed, and/or some of the blocks described may be changed, eliminated, or combined.

As mentioned above, the example processes of FIG. 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIG. 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

The process of FIG. 7 begins at block 702 with the key findings identifier 118 reviewing a clinical report associated with an image (block 702). The key findings identifier 118 reviews the clinical report to identify a parameter (e.g., parameter of interest) within the report (block 704). In some examples, the parameter is dynamically identified by the key findings identifier 118 by comparing one or more words or phrases within the clinical report to a reference list of parameters. Some parameters may include breast density, breast texture, breast lesion, etc. However, different parameters may be identified based on the patient, the modality, etc. The key findings identifier 118 searches for and/or reviews other data to identify relevant findings based on the parameter (block 706). For example, the key findings identifier 118 reviews and/or parses through cases stored in a database to identify one or more similar cases based on the identified parameter, symptoms of the patient, the patient history, the patient information, etc. The similar cases may be related to the patient or another individual.

In response to data identified by the key findings identifier 118, the analyzer 120 identifies a portion of the image associated with the parameter (block 708). At block 710, the analyzer 120 labels the portion of the image with the name of the parameter (block 710). In some examples, labeling the image with the parameter name enables the mapper 121 to map the imaging data and the non-imaging data to a model. For example, a link may be established between the labeled portion of the image and a parameter field on the non-imaging data and/or the selected template. The analyzer 120 determines a value of the parameter (block 712). For example, the analyzer 120 determines a measurement of a lesion identified.

The mapper 121 updates the clinical report based on the value of the parameter (block 714) by, for example, mapping the determined value to the clinical report and/or a template. In some examples, the output generator 114 automatically populates the clinical report and/or a template with the value determined by the analyzer 120. The mapper 122 maps the labeled image, the relevant findings and the updated clinical report to a model for further analysis and/or use in clinical decision support (block 716). In examples in which a breast density value is determined to be relatively high, in some examples, the analyzer 120 determines a parenchymal texture value and a distribution of fibroglandular tissue. In some examples, the values determined based on the analysis are used to determine a BI-RAD score and/or one or more recommendations based on the BI-RAD score.

FIG. 8 is a block diagram of an example processor platform 800 capable of executing the instructions of FIG. 7 to implement the healthcare environment 100 of FIG. 1. The processor platform 800 can be, for example, a server, a personal computer, a mobile device (e.g., a cell phone, a smart phone, a tablet such as an iPad™), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIG. 7 may be stored in the mass storage device 828, in the volatile memory 814, in the non-volatile memory 816, and/or on a removable tangible computer readable storage medium such as a CD or DVD.

From the foregoing, it will be appreciated that the above disclosed methods, apparatus and articles of manufacture use medical ontology to convert unstructured textual and imaging data into a structured form. In some examples, once the data (e.g., imaging data, non-imaging data) is converted and/or mapped into a structured form using, for example, medical ontology, data tagging, content based information access and/or mining (e.g., data mining) is enabled. In some examples, the structured data is stored in connection with an imaging and clinical data archiving system(s).

In some examples, data, recommendations, knowledge and/or analytics is performed on and/or obtained based on the structured data to provide assistance in connection with clinical reporting and/or decision support. In some examples, the clinical reporting includes a pre-draft structured clinical report, error checking, an update on disease progress, anomaly detection, etc. In some examples, the decision support includes calculating population statistics from the data (e.g., relevant archived data), correlating clinical information from different sources, find a reference case(s), etc.

The examples disclosed herein enable big data/analytics in the medical domain because, for example, the clinical data is provided in a structured manner using standard medical ontology. In some examples, the examples disclosed herein provide a relatively complete offering to enable a structured form of imaging and clinical data. In some examples, existing systems can be updated with the examples disclosed herein. In some examples, image processing data and/or capabilities is aggregated and/or integrated with imaging and/or non-imaging data and/or archives to enable diagnostic level support using, for example, case storage and/or retrieval processes that index content information and/or context information (e.g., large scale data) and textual medical data.

In some examples, to enable decision support, the examples disclosed herein use example retrieval processes to retrieve similar historical cases (e.g., images and reports) and/or external publications. In some examples, based on the relevance and/or the context of the retrieved data, the examples disclosed herein display a “snapshot” view and/or a brief summary to a practitioner to enable the practitioner to efficiently browse through the retrieved data to identify and/or obtain the information and/or relevant data from the retrieved results. Using the examples disclosed herein and/or the retrieved and/or determined data, practitioners can obtain suggested diagnoses and/or perform expert-guided image analytics. In some examples, the image analytics include key anatomical feature labeling, segmentation, automatic measurements, etc. to enable clinical decision support and/or decision making. In some examples, structurally representing imaging and/or non-imaging data and/or providing links between the imaging and/or non-imaging data enables analytics to be performed. In some examples, the examples disclosed herein provide decision support in an imaging system to, for example, improve accuracy and/or efficiency in diagnose. In some examples, one or more aspects of the examples disclosed herein may be implemented as a plugin that is integratable into a current imaging system(s).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
parsing a clinical report to identify a parameter within the clinical report and associated with an image, the clinical report being associated with the image;
when the parameter is identified in the parsing, analyzing the image to determine a value of the parameter;
mapping the value, the image, and the clinical report to a model; and
generating an output to display one or more of the value, the image, or the clinical report.

2. The method of claim 1, further comprising analyzing the image to identify a portion of the image associated with the parameter.

3. The method of claim 2, further comprising labeling the image with the determined value or the parameter.

4. The method of claim 1, wherein the model is generated based on the parameter identified.

5. The method of claim 4, wherein the model is dynamically generated.

6. The method of claim 1, wherein parsing the clinical report comprising parsing the clinical report to dynamically define the parameter.

7. The method of claim 1, wherein parsing the clinical report is at least partially based on a patient symptom or an electronic medical report.

8. The method of claim 1, further comprising, in response to analyzing the image, outlining a portion of the image associated with the parameter.

9. The method of claim 1, wherein analyzing of the image is at least partially based on a similar clinical report or an external reference.

10. The method of claim 8, further comprising mapping the similar clinical report or the external reference to the model.

11. The method of claim 1, further comprising propagating the value within the clinical report.

12. The method of claim 1, further comprising, in response to the analysis, generating data to be used for clinical decision support.

13. The method of claim 12, wherein the data comprises a recommendation.

14. The method of claim 1, wherein the mapping value, the image, and the clinical report to the model comprises establishing a link between the image and the clinical report.

15. The method of claim 1, further comprising labeling an anatomical feature of the image, segmenting the image. or automatically measuring a portion of the image associated with the parameter.

16. An apparatus, comprising:
a key findings identifier to parse a clinical report and identify a parameter within the clinical report, the clinical report being associated with an image;
an analyzer to analyze the image to determine a value of the parameter;
a mapper to map the clinical report, the image, and the value to a model; and
an output to generate an output of one or more of the clinical report, the image, or the value.

17. The apparatus of claim 16, wherein the key findings identifier is to dynamically define the parameter.

18. The apparatus of claim 16, wherein the analyzer is to identify a portion of the image associated with the parameter.

19. The apparatus of claim 16, wherein the analyzer is to label a portion of the image associated with the parameter.

20. The method of claim 16, wherein the analyzer is to generate a clinical recommendation to be used for clinical decision support.
